(19) United States
(12) Patent Application Publication
(10) Pub. No.: US 2014/0043263 A1
(43) Pub. Date: Feb. 13, 2014

(54) METHOD FOR PROCESSING BENDING EVENT IN FLEXIBLE PORTABLE TERMINAL, MACHINE-READABLE STORAGE MEDIUM, AND FLEXIBLE TERMINAL

(71) Applicant: Samsung Electronics Co., Ltd., Gyeonggi-do (KR)

(72) Inventors: Kyung-Wan PARK, Gyeonggi-do (KR); Seok-Myong KANG, Gyeonggi-do (KR); Youn-Ho CHOI, Seoul (KR); Ho-Seong SEO, Gyeonggi-do (KR); Ji-Hyun JUNG, Gyeonggi-do (KR); Shi-Yun CHO, Gyeonggi-do (KR)

(73) Assignee: Samsung Electronics Co., Ltd., Gyeonggi-do (KR)

(21) Appl. No.: 13/960,453

(22) Filed: Aug. 6, 2013

(30) Foreign Application Priority Data
Aug. 13, 2012 (KR) 10-2012-0088385

(51) Int. Cl. G06F 3/041

(52) U.S. Cl. CPC G06F 3/0418
USPC 345/173

(57) ABSTRACT

A method and apparatus for processing a bending event of a touch screen in a portable terminal. The method includes counting a number of touch sensing values of the touch screen; comparing the number of the touch sensing values with a threshold; determining that a bending event occurs in the touch screen when the number of the touch sensing values is at least equal to the threshold; and performing at least one of correction of an error of the touch sensing values, a function of the portable terminal allocated to the bending event upon a determination that the bending event occurs.

### PRIORITY

This application claims priority under 35 U.S.C. §119(a) to Korean Application Serial No. 10-2012-0088385, which was filed in the Korean Intellectual Property Office on Aug. 13, 2012, the entire content of which is incorporated herein by reference.

### BACKGROUND OF THE INVENTION

1. Field of the Invention

The present invention generally relates to a touch interface, and more particularly, to a method and apparatus for preventing erroneous touch recognition.

2. Description of the Related Art

The emergence of new flexible displays, which are next-generation displays, foreshadows the appearance of new flexible apparatuses. This emergence will result in new apparatuses and new paradigms that are different from existing Information Technology (IT) devices. Touch type input devices that are intuitive and easy to use may become widely used as input devices for flexible apparatuses, regardless of the types of these apparatuses. A touch screen applied to a flexible apparatus should provide reliable function and performance, and at the same time, should have a certain longevity. In order to find suitable elements for creating such devices, research have been mainly performed with respect to capacitive touch screens using electrodes that have excellent flexibility and pressure sensitive touch screens that have excellent flexibility and are sensitive to a change of resistance.

A flexible apparatus provided with such a touch screen may use an additional sensor to sense bending or folding. However, use of such a sensor in a device requires additional costs and signal processing algorithms.

### SUMMARY OF THE INVENTION

The present invention has been provided to at least partly solve, alleviate or remove at least one of the above-described problems and/or disadvantages related to the prior art and provide at least the advantages described below.

An aspect of the present invention is to provide a method that may recognize bending or folding in a flexible apparatus provided with a capacitive touch screen capable of being used as an input device, without an additional sensor, and compensate touch sensing values caused by the bending or folding, thereby preventing erroneous touch recognition.

According to an aspect of the present invention, a method of processing a bending event of a touch screen in a portable terminal is provided. The method includes counting a number of touch sensing values of the touch screen; comparing the number of the touch sensing values with a threshold; determining that a bending event occurs in the touch screen when the number of the touch sensing values is at least equal to the threshold; and performing at least one of correction of an error of the touch sensing values, and a function of the portable terminal allocated to the bending event upon a determination that the bending event occurs.

According to another aspect of the present invention, a flexible portable terminal is provided. The flexible portable terminal includes a display unit configured to display an image; a touch panel configured to output touch sensing values; and a control unit configured to count the number of touch sensing values of the touch panel, to compare the number of the touch sensing values with a threshold, to determine a bending event occurs in the touch panel when the number of the touch sensing values is at least equal to the threshold, and to perform at least one of correction of an error of the touch sensing values and a function of the portable terminal allocated to the bending event upon a determination that the bending event occurs.

According to another aspect of the present invention, a machine-readable storage medium in which a program for executing a method is provided. The method includes counting a number of touch sensing values of the touch screen; comparing the number of the touch sensing values with a threshold; determining that a bending event occurs in the touch screen when the number of the touch sensing values is at least equal to the threshold; and performing at least one of correction of an error of the touch sensing values, and a function of the portable terminal allocated to the bending event upon a determination that the bending event occurs.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram illustrating a configuration of a portable terminal according to an embodiment of the present invention;

FIG. 2 is a diagram illustrating an outline external appearance of a portable terminal according to an embodiment of the present invention;

FIG. 3 is an exploded perspective diagram illustrating a principal configuration of the portable terminal according to an embodiment of the present invention;

FIG. 4 is a cross-sectional diagram illustrating a part of a flexible printed circuit board assembly according to an embodiment of the present invention;

FIG. 5 is a plan diagram illustrating the flexible printed circuit board assembly according to an embodiment of the present invention;

FIG. 6 is a diagram illustrating an example of a rigid region including a control unit according to an embodiment of the present invention;

FIG. 7 is a plan diagram illustrating a flexible printed circuit board assembly according to another embodiment of the present invention;

FIG. 8 is a plan diagram illustrating a flexible printed circuit board assembly according to still another embodiment;

FIG. 9 is a cross-sectional diagram illustrating a touch screen according to an embodiment of the present invention;

FIG. 10 is a diagram for exemplifying a pattern of a sensing pattern layer according to an embodiment of the present invention;

FIG. 11 is a graph exemplifying a capacitance distribution when the touch screen is bent according to an embodiment of the present invention;

FIG. 12 is a flow chart illustrating a method of preventing erroneous touch recognition caused by bending according to an embodiment of the present invention;

FIGS. 13 to 18 are tables corresponding to a matrix structure of sensing points according to methods of preventing erroneous touch recognition caused by bending according to an embodiment of the present invention;

FIGS. 19A to 19C are diagrams illustrating execution of a multimedia control function according to a bending event in accordance with a first example according to an embodiment of the present invention;

FIGS. 20A to 20C are diagrams illustrating execution of a multimedia control function according to a bending event in accordance with a second example according to an embodiment of the present invention;

FIGS. 21A and 21B are diagrams illustrating execution of a multimedia control function according to a bending event in accordance with a third example according to an embodiment of the present invention;

FIGS. 22A and 22B are diagrams illustrating execution of a interface change function according to a bending event according to an embodiment of the present invention; and

FIGS. 23A and 23B are diagrams illustrating execution of a mode change function according to a bending event according to an embodiment of the present invention.

### DETAILED DESCRIPTION OF EMBODIMENTS OF THE PRESENT INVENTION

Hereinafter, various embodiments of the present invention will be described with reference to the accompanying drawings. In the following description, the same elements will be designated by the same reference numerals although they are shown in different drawings. Further, various specific definitions found in the following description are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention unclear.

Terms including an ordinal number such as first or second are used so as to describe various constitutional elements but the constitutional elements are not limited by the terms. The terms are used merely for the purpose of differentiating one constitutional element from other constitutional elements. For example, a first constitutional element may be referred to as a second constitutional element without departing from the scope of the present invention to be protected, and similarly, the second constitutional element may also be referred to as the first constitutional element. The term, “and/or,” should be interpreted to include any combination of a plurality of related described items or any one of the related described items.

The terms used herein are merely used to describe a specific embodiments and do not limit the scope of the present invention. A singular expression includes a plural expression unless clearly different in context. Herein, terms such as “include” and “have” are used to merely to designate that a feature, a number, a step, an operation, a constitutional element, a part or a combination thereof exists and are not intended to exclude in advance a possibility of existence or addition of one or more other features, numbers, steps, operations, constitutional elements, parts or combinations thereof.

Unless otherwise defined, all terms used herein including a technical or scientific term have a meaning equal to that generally understood by a person having an ordinary skill in the art to which the present invention belongs. Terms such as those defined in a generally used dictionary should be interpreted as having a meaning that coincides with a contextual meaning of the terms in a related description, and are not interpreted as an ideal or excessively formal meaning unless apparently defined herein.

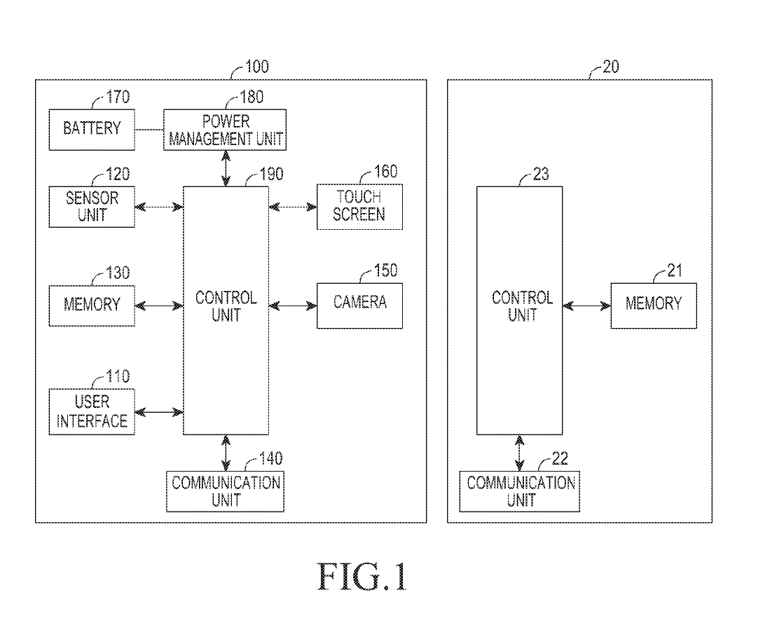

FIG. 1 is a diagram illustrating a configuration of a portable terminal according to an embodiment of the present invention.

The portable terminal 100 may be, for example, a smart phone, a portable phone, a game machine, a TeleVision (TV), a display device, a vehicular head unit, a notebook Personal Computer (PC), a laptop PC, a tablet PC, a Personal Media Player (PMP), or a Personal Digital Assistant (PDA). The portable terminal 100 may be implemented as a pocket size portable mobile terminal with a wireless communication function.

The portable terminal 100 includes a user interface 110, a sensor unit 120, a memory 130, a communication unit 140, a camera 150, a touch screen 160, a power management unit 180, a battery 170, and a control unit 190.

The user interface 110 receives a user input and informs a user of information and may further include a speaker, a microphone, a plurality of buttons, a vibration motor, a connector, a keypad, etc. (not shown). The user interface 110 is not limited to these examples, and cursor control units such as a mouse, a trackball, a joystick or cursor direction keys may be provided to control information communication with the control unit 190 and the curser movement on the touch screen 160, in accordance with embodiments of the present invention.

The speaker output sounds corresponding to various signals (e.g., a wireless signal, a broadcasting signal, a digital audio file, a digital moving image file or photographing) to the outside of the portable terminal 100 according to a control of the control unit 190. The speaker also outputs sounds corresponding to functions executed by the portable terminal 100. At a suitable position or positions on the portable terminal 100, one speaker or a plurality of speakers may be provided.

The microphone receives a voice or sound and generates an electrical signal according to a control of the control unit 190.

The buttons may be provided on the front surface, the lateral surfaces or the rear surface of the portable terminal 100 and may include, for example, a power/lock button, a volume button, a menu button, a home button, a back button, and a search button.

The vibration motor converts an electrical signal into a mechanical signal according to a control of the control unit 190. For example, when the mobile apparatus 100 set to a vibration mode receives a voice or image call from any other apparatus (not shown), the vibration motor is operated. One or more vibration motors may be provided in the mobile apparatus 100. The vibration motor may be operated in response to a user's touch action that touches the touch screen 160 and/or a continuous movement of the touch on the touch screen 160.

The connector is used as an interface that interconnects the mobile apparatus 100 and a server, an external apparatus (not shown) or a power source (not shown). The mobile apparatus 100 may transmit data stored in the memory of the mobile apparatus 100 to the external apparatus or receive data from the external apparatus through a wired cable connected to the connector according to the control of the control unit 190. Power may be input to the battery 170 from the power source through the wired cable connected to the connector.

The keypad receives key input from the user so as to control the mobile apparatus 100. The keypad includes a physical keypad formed on the mobile apparatus 100 or a virtual keypad displayed on the touch screen.

The touch screen 160 is a flexible touch screen that may be bent or folded. The touch screen 160 displays an image according to a control of the control unit 190, generates a key contact interrupt when a user input means, such as a finger or a stylus pen, touches the surface of the touch screen 160, and outputs the user input information including an input coordinate and an input condition to the control unit 190 according to a control of the control unit 190.

The touch screen 160 provides a plurality of user interfaces that correspond to various services (e.g., phone call, data transmission, broadcasting and still image/moving image photographing), respectively, to the user. The touch screen 160 transmits the user input information corresponding to at least one touch input to a Graphical User Interface (GUI) to the control unit 190. The touch screen 160 receives at least one touch through the user's body (e.g., fingers including a thumb) or a touchable input means (e.g., a stylus pen). In addition, the touch screen 160 may receive an input of continuous movement of one touch among one or more touches. The touch screen 160 transmits the user input information corresponding to the continuous movement of the touch input to the touch screen to the control unit 190.

According to embodiments of the present invention, the touch is not limited to a contact between the touch screen 160 and the user's body or a touchable input means and includes a contactless touch (e.g., a detectable space between the touch screen 160 and the user's body or a touchable input means less than a set distance, such as 1 mm, for example). The touch screen 160 may be implemented, for example, as a capacitive type touch screen.

The sensor unit 120 includes at least one sensor (not shown) that detects a condition of the mobile apparatus 100. For example, at least one sensor included in the sensor module 120 may include a proximity sensor that detects whether the user approaches to the mobile apparatus 100 or a motion/bearing sensor that detects the operation of the mobile apparatus 100 (e.g., rotation or acceleration or vibration of the mobile apparatus 100. In addition, the motion/bearing sensor may include, for example, an acceleration sensor, a gravity sensor, a terrestrial magnetism sensor, a gyro sensor, an impact sensor, a Global Positioning System (GPS) sensor, and a compass sensor. The sensor unit 120 detects a condition of the portable terminal 100 and generates and transmits a signal corresponding to the detection to the control unit 190. For example, the GPS sensor may receive radio waves from a plurality of GPS satellites (not shown) in Earth orbit, and calculate a position of the portable terminal 100 using a time of arrival of the radio waves from the GPS satellites (not shown) to the portable terminal 100. The compass sensor may calculate the posture or bearing of the portable terminal 100.

The communication unit 140 is provided for direct connection or connection through a network with a server or an external apparatus. The communication unit 140 may be a wired or wireless communication unit. The communication unit 140 transmits data from, for example, the control unit 190, the memory 130, or the camera 150 and/or receives data from an external communication apparatus or the atmosphere to transfer the data to the control unit 190 or store the data in the memory 130.

The communication unit 140 may include at least one of a mobile communication module, a wireless Local Area Network (LAN) module, and a near field communication module (not shown). The communication unit 140 may further include, but not exclusively, at least one of a Digital Multimedia Broadcasting (DMB) module, an Integrated Service Digital Network (ISDN) card, a Local Area Network (LAN) card, an infra-red card, a Bluetooth port, and a Zigbee module.

The mobile communication module allows the user terminal 100 to be connected with an external apparatus through mobile communication using one or more antennas (not shown) according to a control of the control unit 190. The mobile communication module may transmit/receive a wireless signal for data exchange or one-way transmission/reception such as voice communication, image communication, text message (e.g., a Short Message Service (SMS) message), or multimedia message (e.g., a Multimedia Message Service (MMS) message) with a portable phone (not shown), a smart phone (not shown), a tablet PC, or other apparatuses (not shown) which has a phone number or a network address input to the portable terminal 100.

The wireless LAN module may be connected to the Internet according to a control of the control unit 100 in a place where a wireless Access Point (AP) (not shown) is installed. The wireless LAN module supports the wireless LAN standard (IEEE802.11x) of the Institute of Electrical and Electronic Engineers (IEEE). The near field communication module may perform near field communication wirelessly between the user terminal 100 and an image forming apparatus (not shown) according to a control of the control unit 190. The near communication method may include, for example, Bluetooth and IrDA (Infrared Data Association) communication.

The camera 150 may include, for example, a lens system, an image sensor, and a flash. The camera 150 converts an optical signal input (i.e., photographed) through the lens system into an electrical image signal and outputs the electrical image signal to the control unit 190. The camera 150 may be used to photograph a moving image or a still image.

The lens system causes light incident from the outside to converge to form an image of a subject. The lens system includes one or more lenses, each of which may be, for example, a convex lens or an aspheric lens. The lens system is symmetric with respect to an optical lens that passes the center of the lens system in which the optical axis is defined as the central axis. The image sensor detects an optical image formed by the external light incident through the lens system as an electrical image signal. The image sensor includes a plurality of pixel units arranged in an M×N matrix structure and each of the pixel units may include a photodiode and a plurality of transistors. The pixel units accumulate electric charges generated by the incident light and the voltage induced by the accumulated electric charges indicates the intensity of illumination of the incident light. In processing an image that forms a still image or a moving image, the image signal output from the image sensor is configured by an aggregation of the voltages (i.e., pixel values) output from the pixel units and the image signal indicates one frame (i.e., a still image). The frame is configured with dimensions of M×N pixels. As the image sensor, for example, a Charge-Coupled Device (CCD) image sensor or a Complementary Metal-Oxide Semiconductor (CMOS) image sensor may be used.

The drive unit drives the image sensor according to a control of the control unit 190. The drive unit operates all pixels of an image or only the pixels of a region of interest among all pixels according to a control signal received from the control unit 190 and the image data output from the pixels is output to the control unit 190.

The control unit 190 processes the images input from the camera 150 or images stored in the memory 130 frame by frame, and outputs image frames converted to be suitable for screen properties (size, quality of image, definition or the like) of the touch screen 160.

The memory 130 may store, for example, applications of various functions such as navigation, image communication, and game functions, Graphical User Interfaces (GUI) related thereto, user information, documents, databases or data related to the method of preventing erroneous touch recognition or a method of processing a bending event of the touch screen, background images or operation programs required for driving the portable terminal 100 (e.g., a menu screen and a standby screen) and photographed images. The memory 130 is a medium that is readable using a machine (e.g., a computer) and the term, “machine-readable medium,” may be defined herein as a medium that provides data for the machine so that the machine may perform a specific function. The machine-readable medium may be a storage medium. The memory 130 may include a non-volatile medium and/or a volatile medium. These media allow commands transferred by the media to be detected by a physical instrument in which the machine reads the commands into the physical instrument.

The machine-readable media may include, but are not limited to, at least one of a floppy disc, a flexible disc, a hard disc, a magnetic tape, a Compact Disc Read Only Memory (CD-ROM), an optical disc, a punch card, a paper tape, a Random Access Memory (RAM), a Programmable Read-Only Memory (PROM), an Erasable PROM (EPROM) and a Flash EPROM (FEPROM).

The power management unit 180 supplies power to the portable terminal 100 according to a control of the control unit 190. The power management unit 180 is connected with the battery 170 and monitors the charged condition of the battery 170.

The control unit 190 executes an application according to user input information and the application performs a program operation according to the user input information. At this time, the user input includes an input through, for example, the keypad or the touch screen, or a camera-based input. The control unit 190 may include a bus for information communication and a processor connected with the bus for information processing. The control unit 190 may also include a RAM connected with the bus so as to store information requested by the processor. The RAM may be used to store temporal information requested by the processor. The portable terminal 100 may further include a ROM connected with the bus so as to store static information requested by the processor. The control unit 190 is a central processing unit that serves to control the entire operation of the portable terminal 100 and to perform a function according to the inventive method of preventing erroneous touch recognition and/or a folding or bending event. When the touch screen 160 is bent, the control unit 190 performs a process for preventing erroneous touch recognition that may be caused by such bending. Such a process may also be applied to prevent erroneous touch recognition caused by circuit noise in the touch screen 160. The control unit 190 also performs a function according to the folding or bending of the touch screen 160.

A program providing device 20 includes a memory 21 configured to store a program including commands that instruct a function according to the method of preventing erroneous touch recognition and/or a folding or bending and update information of the program, a communication unit 22 configured to perform wired or wireless communication with the portable terminal 100, and a control unit 23 configured to transmit a corresponding program or update information to the portable terminal, either according to a request from the portable terminal 100 or automatically.

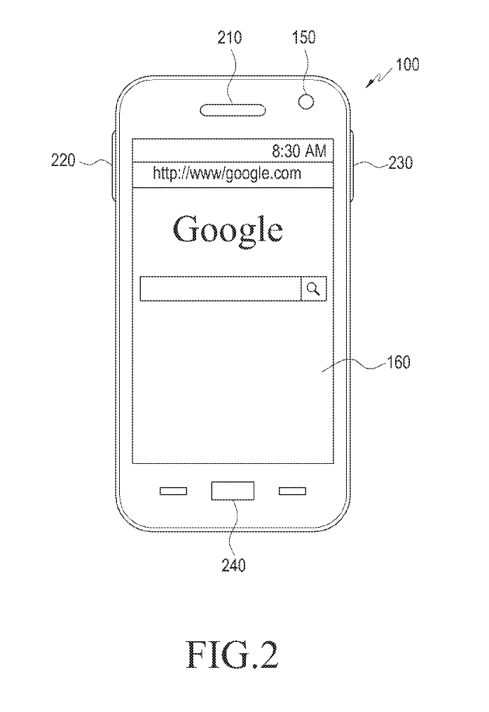

FIG. 2 illustrates an outline configuration of a portable terminal according to an embodiment of the present invention.

FIG. 2 illustrates a touch screen 160 disposed on the front surface of the portable terminal 100, a speaker 210 and a camera 150 disposed above the touch screen 160, and a home button 240 disposed below the touch screen 160. On one lateral surface of the portable terminal 100, a volume button 220 is disposed, and on the other later surface of the portable terminal 100, a power button 230 is provided.

FIG. 3 is an exploded perspective diagram illustrating a principal configuration of the portable terminal according to an embodiment of the present invention.

Referring to FIG. 3, the portable terminal 100 has a configuration in which a battery 170, a flexible Printed circuit Board Assembly (PBA) 310 and a flexible touch screen 160 are stacked in order from the bottom to the top such that they are in close contact with each other or partly or entirely spaced apart from each other. The touch screen 160 also has a configuration in which a display unit 370, a sensor layer 350 and a window 340, which form a touch panel 360, are stacked in this order from the bottom to the top in close contact with each other or partly or entirely spaced apart from each other. Each of the touch panel 360 and the display unit 370 has flexibility and elasticity.

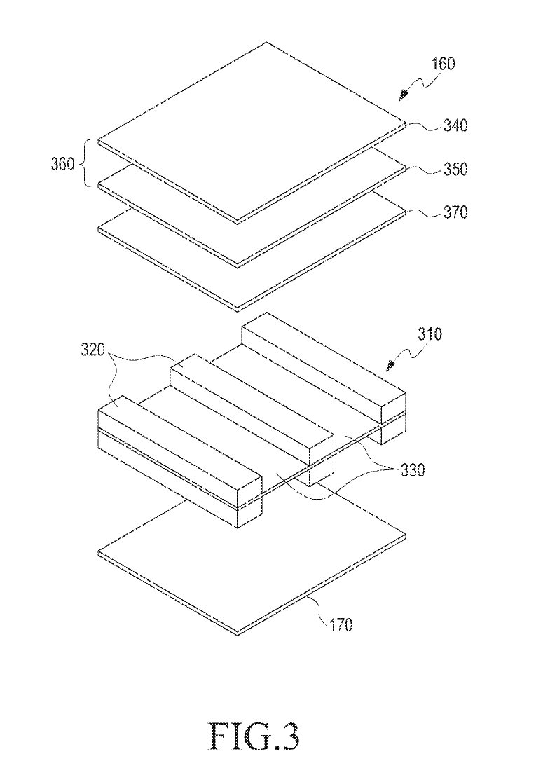

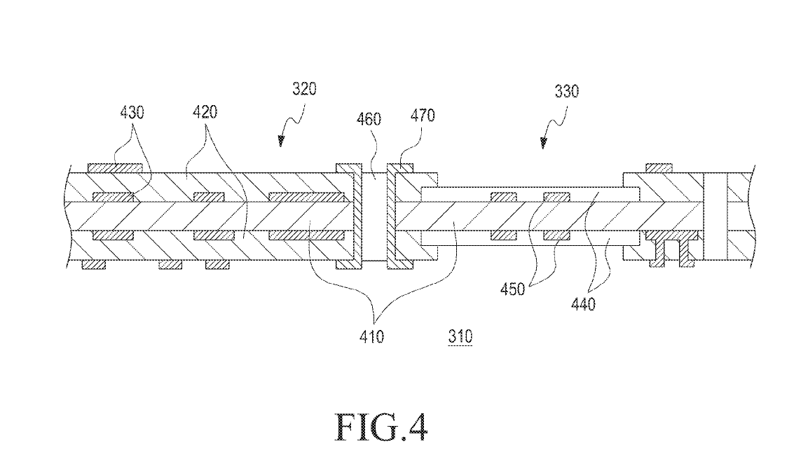

FIG. 4 is a cross-sectional diagram illustrating a part of the flexible printed circuit board assembly and FIG. 5 is a plan diagram illustrating the flexible printed circuit board assembly according to an embodiment of the present invention.

The printed circuit board assembly 310 has a configuration in which a plurality of rigid regions 320 and a plurality of flexible regions 330 are alternately arranged and connected, from one side to the other side thereof. The rigid regions 320 include non-flexible circuit modules such as an Integrated Circuit (IC), a Resistor (R), an Inductor (L), a Capacitor (C), and a connector and the flexible regions 330 include electric wiring that connects the circuit modules of the rigid regions 320.

Each rigid region 320 is configured by stacking a plurality of insulation layers 420 and a plurality of conductive layers 430 for electrical wiring on an insulative core layer 410. Similarly, each flexible region 330 is configured by stacking a plurality of insulation layers 440 and a plurality of conductive layers 450 for electrical wiring on the insulative core layer 410. A via hole 460 is provided through at least one insulation layer 420 for inter-layer electric connection in the rigid regions 320 in which the inside of the via hole 460 is partially or entirely filled with a conductive material 470.

The flexible region 330 electrically connects two adjacent rigid regions 320 and each rigid region 320 includes at least one circuit module. The circuit modules correspond to at least one of the user interface 110, the sensor unit 120, the memory 130, the communication unit 140, the camera 150, the touch screen 160, and the control unit 190, respectively.

Referring to FIG. 5, first and second flexible region 331 and 332 are disposed between the first to third rigid regions 321, 322 and 323 and first to third rigid regions 321, 322, and 323.

The first rigid region 321 includes the communication unit 140, the second rigid region 322 includes the memory 130 and the control unit 190, and the third rigid region 323 includes the power management unit 180.

Each of the elements of the portable terminal 100 illustrated in FIG. 1 may be configured by a plurality of circuit modules. For example, the control unit 190 may include a display unit control module configured to display an image of the touch screen 160 and an application processor module configured to execute an application. Also, the power management unit 180 may include a plurality of power management modules and the communication unit 140 may include, for example, a main communication module, a Bluetooth module, and a DMB module. In addition, these modules may be arranged in distribution over the first to third rigid regions 321, 322, and 323.

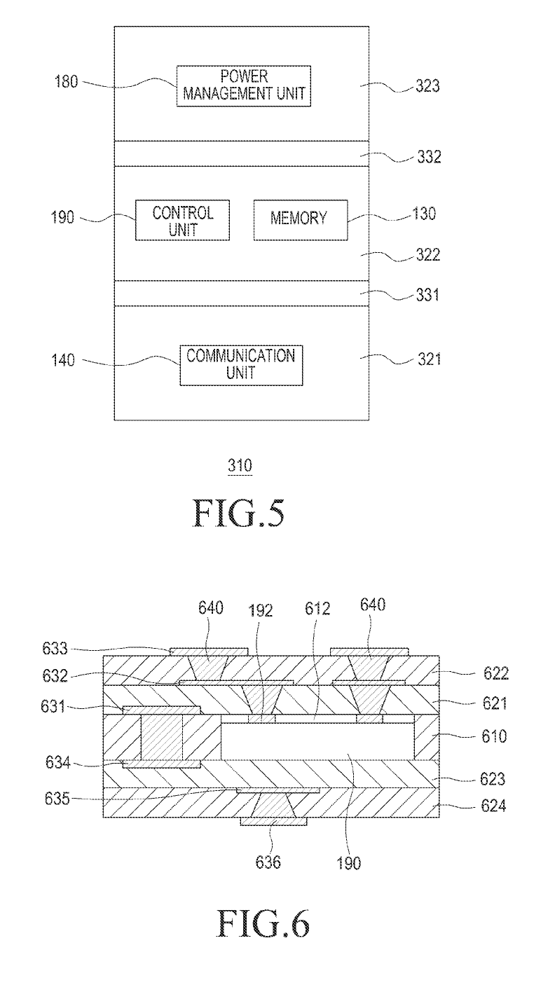

FIG. 6 illustrates an example of a rigid region including a control unit according to an embodiment of the present invention. A control unit 190 in the form of an integrated circuit is positioned within a hole 612 formed through an insulative core layer 610, and a first conductive layer 631, a first insulation layer 621, a second conductive layer 632, a second insulation layer 622, and a third conductive layer 633 are stacked in this order on the top surface of the insulative core layer 610, and a fourth conductive layer 634, a third insulation layer 623, a fifth conductive layer 635, a fourth insulation layer 624, and a sixth conductive layer 636 are stacked in this order on the bottom surface of the insulative core layer 610. At least one via hole 640 is provided through the insulative core layer 610 and each of the insulation layers 621 to 624 for the inter-layer electrical connection between the conductive layers 631 to 636, and each via hole 640 is formed by a hole extending through a corresponding insulation layer in which the inside of each via hole 640 is filled with a conductive material. The electrical connection between the conductive layers is formed through the via holes 640. The bumps 192 disposed on the surface of the control unit 190 are electrically connected with the second conductive layer 632 through the via holes 640.

Referring to FIG. 5 again, the printed circuit board assembly 310 is bendable at the flexible regions 331 and 332. More specifically, the printed circuit board assembly 310 may be bent with reference to the first or second flexible region 331 and 332. In the present example, since the printed circuit board assembly 310 includes linear flexible regions 331 and 332, only mono-axial (e.g., X-axis) bending is enabled. In the present example, the X-axis is in the direction where each of the flexible regions 331 and 332 extends.

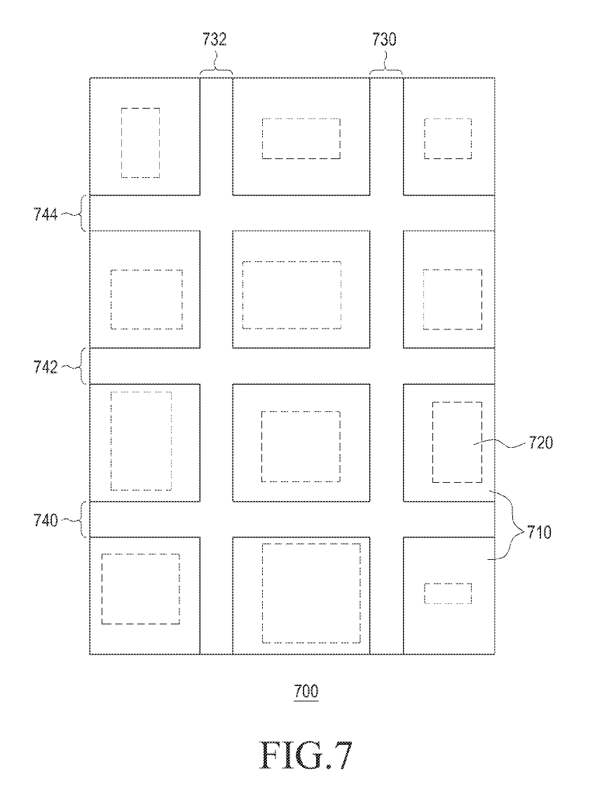

FIG. 7 is a plan diagram illustrating a flexible printed circuit board assembly according to another example in accordance with an embodiment of the present invention.

Referring to FIG. 7, the printed circuit board assembly 700 includes rigid regions 710 arranged in three rows and four columns in the form of a 3×4 matrix, flexible regions 730 and 732 of the first and second rows and flexible regions 740, 742, and 744 of first to third columns, which are arranged in a grid form to electrically connect the adjacent rigid regions 710. The rigid regions 710 arranged in three rows and four columns include non-flexible circuit modules 720 and the flexible regions 730 to 744 (i.e., flexible regions 730, 732, 740, 742, and 744) include electrical wiring (i.e., the conductive layer 450 as illustrated in FIG. 4) that connects the circuit modules 720 of the rigid regions 710. The areas where the flexible regions 730 to 744 intersect do not include electrical wiring. The flexible regions 730 and 732 of each row electrically connect the rigid regions 710 of adjacent rows and the flexible region 740 and 744 of each column electrically connect the rigid regions 710 of adjacent columns.

In this configuration, the printed circuit board assembly 700 is bendable with respect to each of the flexible regions 730 to 744. More specifically, the printed circuit board assembly 700 may be bent with respect to the flexible region 730 or 732 of the first or second row (e.g., in a direction along a Y-axis) or with reference to the flexible region 740, 742 or 744 of the first, second or third column (e.g., in a direction along an X-axis). In the present example, since the printed circuit board assembly 700 includes the flexible regions 730 to 744 in the grid form, bi-axial (i.e., either the X-axis or Y-axis) bending is enabled. In the present example, the Y-axis extends in the direction where the flexible region 730 or 732 in the first or second row and the X-axis extends in the direction where the flexible region 740, 742 or 744 of the first, second or third column extends.

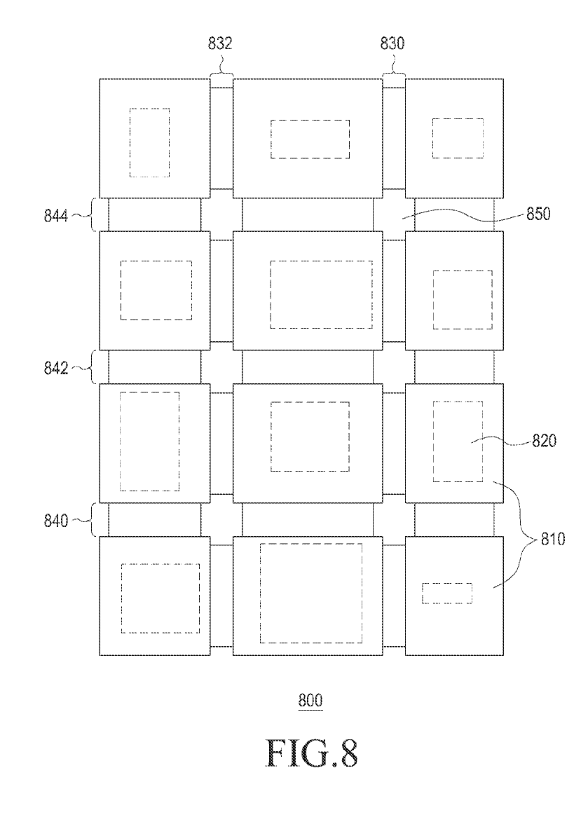

FIG. 8 is a plan diagram illustrating a flexible printed circuit board assembly according to another example in accordance with an embodiment of the present invention. The flexible printed circuit board assembly 800 has a configuration similar to that of the flexible printed circuit board assembly 700 illustrated in FIG. 7, except that the areas where the flexible regions 830 to 844 intersect and no electrical wiring exists are removed.

The printed circuit board assembly 800 includes rigid regions 810 arranged in three rows and four columns in the form of a 3×4 matrix, and flexible regions 830 and 832 in the first and second rows and flexible regions 840 to 844 in the first to third columns having a grid form to electrically connect the adjacent rigid regions 810. The rigid regions 810 arranged in three rows and four columns include non-flexible circuit modules 820 and the flexible regions 830 to 844 include only electric wiring that connects the circuit modules 820 of the rigid regions 810. The areas where the flexible regions 830 to 844 (i.e. regions 830, 832, 840, 842, and 844) intersect do not include electrical wiring. The flexible regions 830 and 832 of each row electrically connect the rigid regions 810 of adjacent rows and the flexible region 840 to 844 of each column electrically connect the rigid regions 810 of adjacent columns.

Each of the flexible regions 830 and 832 of the first and second rows includes four flexible sub-regions separated from each other by cross holes 850 formed through the printed circuit board assembly 800 and each of the flexible regions 840 to 844 of the first to third columns includes three sub-regions separated from each other by the cross holes 850.

The touch panel 360 illustrated in FIG. 3 includes a sensor layer 350 so as to determine the input position of the user input means and/or bending in which such a sensor layer 350 may be stacked on the window 340 in a state in which the sensor layer 350 is stacked on a separate board, or directly stacked on the window 340.

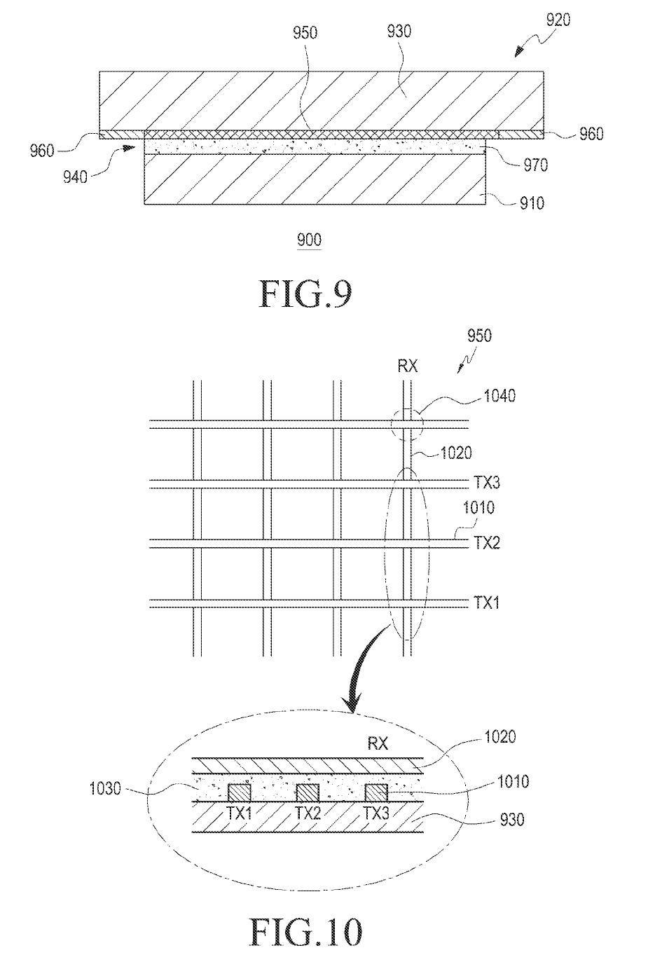

FIG. 9 illustrates a touch screen according to an embodiment of the present invention. The touch screen 900 illustrated in FIG. 9 may be considered as a specific example of the touch screen 160 illustrated in FIGS. 1 to 3.

Referring to FIG. 9, the touch screen 900 includes a display unit 910 and a touch panel 920. The touch panel 920 includes a window 930, and a sensor layer 940 that is provided with a sensing pattern layer 950 and connection terminals 960. The sensor layer 940 is a sensor configured to sense a position on the surface of the window 930 where a user's fingertip or any other object is touched. For this purpose, the sensing pattern layer 950 includes pre-set patterns.

The display unit 910 includes a plurality of pixels and displays images through the pixels. A part (e.g., a central portion) of the top surface of the display unit 910 may be included in an effective display region of the touch screen 100 that is displayed to a viewer. In the present example according to FIG. 9, the top surface of the display unit 910 is entirely included in the effective display region. As the display unit 910, for example, a Liquid Crystal Display (LCD), an Organic Light Emitting Diode (OLED) display, or an LED display may be used.

The display unit 910 and the touch panel 920 are adhered to each other by a transparent adhesive member 970.

The window 930 is positioned above the display unit 910 and includes the sensor layer 940 stacked on the bottom surface thereof. The top surface of the window 930 forms at least a part of the front surface of the touch screen 900 exposed to the outside. The window 930 is formed of an insulation material transparent to visible light. Examples of such an insulation material include synthetic resin or plastic such as polyimide and polyethylene terephthalate.

On the top surface of the window 930, a hard coating layer with high hardness for preventing a scratch (not shown) may be laminated. The hard coating layer may have an anti-glare function together with the hardness improvement function. For example, the hard coating layer may be formed of a material that is formed by adding a light-scattering agent to a conventional hard coating agent.

The sensor layer 940 is stacked on the bottom surface of the window 930, and the lower end (or bottom surface of the sensor layer 940 is attached to the upper end (or top surface) of the display unit 910 using the transparent adhesive member 970.

The sensor layer 940 includes a sensing pattern layer 950 and connection terminals 960. The sensor layer 940 configures a sensor that senses a position on the surface of the window 930 where a user's finger tip or another other object is touched. For this purpose, the sensing pattern layer 950 includes a pre-set pattern. The sensing pattern layer 950 may have various patterns such as a linear grid pattern or a diamond pattern. Hereinbelow, the linear grid pattern may be exemplified as follows.

FIG. 10 is a diagram illustrating a pattern of the sensing pattern layer according to an embodiment of the present invention. Referring to FIG. 10, the sensing pattern layer 950 includes first electrode lines 1010 and second electrode lines 1020.

Each of the first electrode lines 1010 extends along a first direction (e.g., in an X-axis or horizontal direction), and is arranged at an equidistant interval or different intervals along a second direction (e.g., in a Y-axis or vertical direction) orthogonal to the first direction.

The second electrode lines 1020 extend along the second direction orthogonal to the first direction and arranged at an equidistant interval or different intervals along the first direction.

In order to electrically insulate the first electrode lines 1010 and the second electrode lines 1020, an insulation layer 1030 is disposed between the first electrode line 1010 and the second electrode line 1020. As a material for the insulation layer 1030, an insulative dielectric material such as silicon dioxide (SiO2) may be used.

The sensing pattern layer 950 is formed of a conductive material transparent to visible light. Examples of such a conductive material include a carbon containing organic material such as Carbon Nano-Tubes (CNTs) and graphene. The sensing pattern layer 950 may be formed by forming a conductive film through a vacuum vapor deposition process and then patterning the conductive film through lithography. Examples of the vacuum deposition process include e-beam evaporation and sputtering.

The connection terminals 960 for applying a voltage (or current) to the sensing pattern layer 950 are stacked on the bottom surface of the window 930 to be positioned outside of the sensing pattern layer 950. More specifically, the connection terminals 960 are disposed outside the sensing pattern layer 950 (i.e., in the peripheral portion of the window 930).

The connection terminals 960 are electrically connected with the sensing pattern layer 950 through connection lines (not shown). The connection terminals 960 and connection lines may be formed together with the sensing pattern layer 950 through a single process or through separate processes. In addition, the connection terminals 960 may be formed of a material that is the same with that of the sensing pattern layer 950 or of a different material (e.g., a soft metal such as copper of several μm or less). The connection terminals 960 may be electrically connected with a flexible printed circuit board (FPCB) for communication with the control unit 190.

The lower end (i.e., the bottom surface) of the touch panel 920 (i.e., the bottom surface of the sensor layer 940) is adhered to the upper end (i.e., the top surface) of the display unit 910 using the transparent adhesive member 970.

The bottom surface of the window 930 may be processed by adding an Anti-Reflective (AR) coating. Such an AR coating layer may include a niobium pentoxide (Nb2O5) layer and a SiO2 layer, and, in such a case, the sensing pattern layer 950 is laminated on the AR coating layer.

Since the top surface of the window 930 is exposed to the outside, a light blocking layer that blocks visible light may be laminated on the peripheral portion of the bottom surface of the window 930 so as to prevent the peripheral portion outside the central portion included in the effective display region from being shown to the outside. The light blocking layer may be formed through a process such as black ink printing. When black ink printing is used, the connection terminals 960 are laminated on the light blocking layer.

In order to perform the sensor function, a voltage (i.e., a scan signal) of a pre-set waveform is applied to the sensing pattern layer 950. When a conductive user input means touches the surface of the window 930, a sensing signal is generated in which the voltage waveform of the sensing signal is changed due to the change of the capacitance value between the sensing pattern layer 950 and the user input means. The control unit 190 analyzes such a sensing signal to determine whether or not the user input means touches the surface of the window 930, and the touch position.

In order to perform the sensor function, voltages (i.e., scan signals) of pre-set waveforms are sequentially applied to the first electrode lines 1010, respectively and the second electrode lines 1020 outputs sensing signals caused by the scan signals. The points where the first and second sensor lines 1010 and 1020 intersect form the sensing points 1040 which are arranged in a matrix structure. Through this process, the user input position is determined as one of the positions of the sensing points 1040. When the user input means touches the surface of the window 930, the capacitance value of at least one of the sensing points 1040 is changed due to variation of the capacitance between the sensing pattern layer 950 and the user input means. Due to the change of capacitance, the voltage waveforms of the sensing signals output from the second electrode lines 1020 are changed, and the input position and/or input pressure of the user input means is determined from the sensing signals of which the voltage waveforms are changed.

FIG. 10 illustrates first electrode lines 1010 TX1, TX2, and TX3 and second electrode lines 1020 RX.

In the illustrated configuration, when the touch screen 900 is bent in a direction emerging from the plane of the drawing with reference to TX2 (i.e., in the front side direction of the touch screen 900), the capacitance values of the sensing points on TX2 increase. However, when the touch screen 900 is bent in the direction penetrating into the plane of the drawing with reference to TX2 (i.e., in the rear side direction of the touch screen 900), the capacitance values of the sensing points on TX2 decrease.

FIG. 11 is a graph exemplifying a capacitance distribution when the touch screen is bent according to an embodiment of the present invention. Referring to FIG. 11, the graph shows a capacitance distribution when the touch screen having the first electrode lines TX1 to TX31 and the second electrode lines RX1 to RX17 are bent with reference to TX23.

In embodiments of the present invention that use a flexible touch screen, a position or portion where the touch screen is bent is substantially constant in most cases. Hereinbelow, as an example of a method of preventing erroneous touch recognition caused by bending according to an embodiment of the present invention, a method is described as an example in which in the matrix of the entire sensing points 1040 of the touch screen 900, a reference column positioned at the center of the matrix is monitored periodically or non-periodically and the output values of the sensing points 1040 are corrected according to a monitoring result. At this time, the reference column corresponds to the pre-set bending or folding position of the touch screen 900. Meanwhile, a method conducted in relation to the sensing points of the reference column may be also applied to a reference column of another position or a plurality of reference columns.

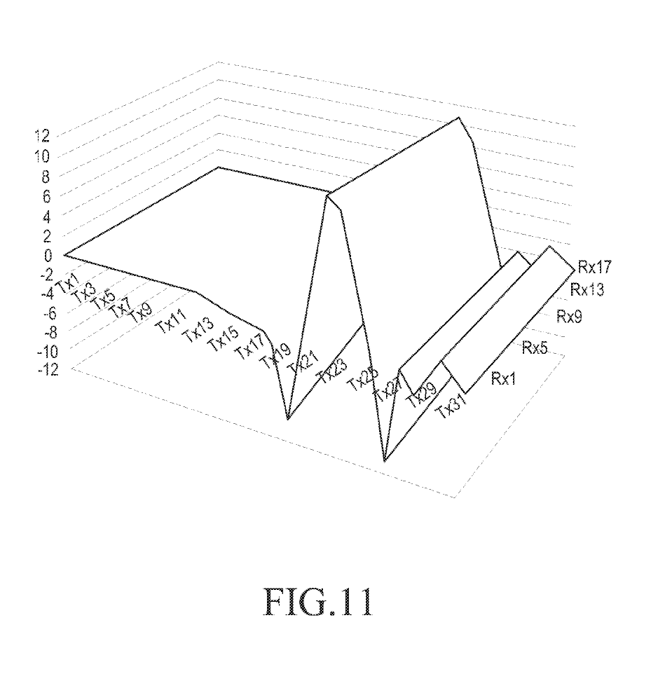

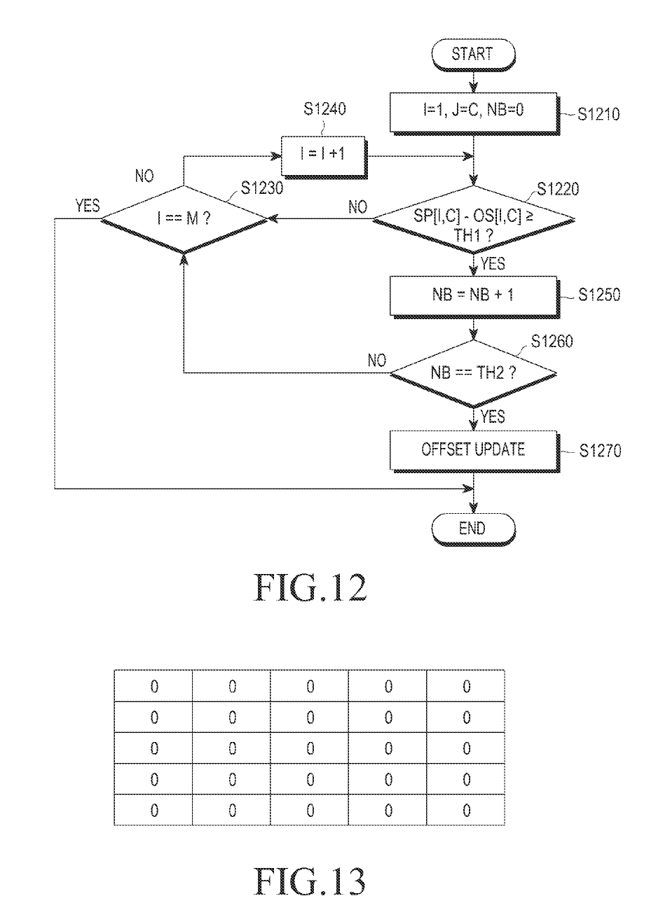

FIG. 12 is a flow chart illustrating a method of preventing erroneous touch recognition caused by bending according to any of the embodiment of the present invention described with reference to FIGS. 13 to 18. Referring to FIG. 12, the method is described as being conducted by the control unit 190 as follows.

Step S1210 is an initialization step where the parameters used include row number I, column number J, and the number of offset-applied objects (hereinafter, referred to as “the number of offsets”) NB, which are initialized to 1, the column number C of the central column of the entire sensing points 1040, and 0, respectively. In the present example, although the monitored reference column is set to the central column of the entire sensing points 1040, the monitored reference column may be any column of the entire sensing points 1040. In addition, according to an embodiment of the present invention all or only a portion of the sensing points in the reference column may be monitored. Further, a plurality of reference columns may be used in which case, steps S1220 to S2160 may be repeated while changing the column numbers. In addition, although the present example is based on a column, the method may be based on a row or a plurality of reference rows may be used. Alternatively, steps S1220 to S1260 may be repeated for sensing points of a predetermined range (e.g., the central portion of the entire sensing points 1040) while changing the row numbers and column numbers.

In step S1220, the control unit 190 compares the output value of each sensing point 1040 of the reference column, SP[I, C], with a previous offset value given to the sensing point 1040, OS[I, C], and determines whether or not the difference therebetween is not less than a predetermined threshold. In step S1220, since SP[I, C]−OS[I, C]≧TH1 may be replaced by SP[I, C]≧TH1+OS[I, C], this step may also be considered as a step of counting the number of touch sensing values of the touch screen 900 which are not less than the first threshold. In other words, the control unit 190 detects touch sensing values, each of which is at least equal to the first threshold, and counts a number of the detected touch sensing values.

When the difference is at least equal to the first threshold, step S1250 is performed, and when the difference is less than the first threshold, step S1230 is performed. Although the present example uses the difference from the offset value as a reference for comparison, the output value of each sensing point 1040 may be used as a reference for comparison in accordance with embodiments of the present invention. The first threshold may be set to a value greater than an average capacitance value induced by the user's touch to be differentiated from a capacitance value by bending.

The values output from the entire sensing points 1040 (i.e., capacitance values or voltage values corresponding thereto) (hereinbelow, referred to as “sensing values” or “touch sensing values”) are stored in the memory 130 periodically and the offset values of a previous period for correcting the output errors of the sensing points 1040 are also stored in the memory 130. The offset values of the previous period are maintained until an update is performed. The above-mentioned difference may be considered as a sensing value corrected by a previous offset value.

FIGS. 13 to 18 are tables corresponding to a matrix structure of sensing points according to methods of preventing erroneous touch recognition caused by bending according to an embodiment of the present invention.

In the examples according to FIGS. 13 to 18, the entire sensing points are arranged in a 5×5 matrix structure. At this time, the unit of the numerical values in FIGS. 13 to 18 is pf.

Referring to FIG. 13, when there is no contact between the touch screen 900 and the user input means and no circuit noise exists in the touch screen 900, all the sensing values of the entire sensing points 1040 may be 0.

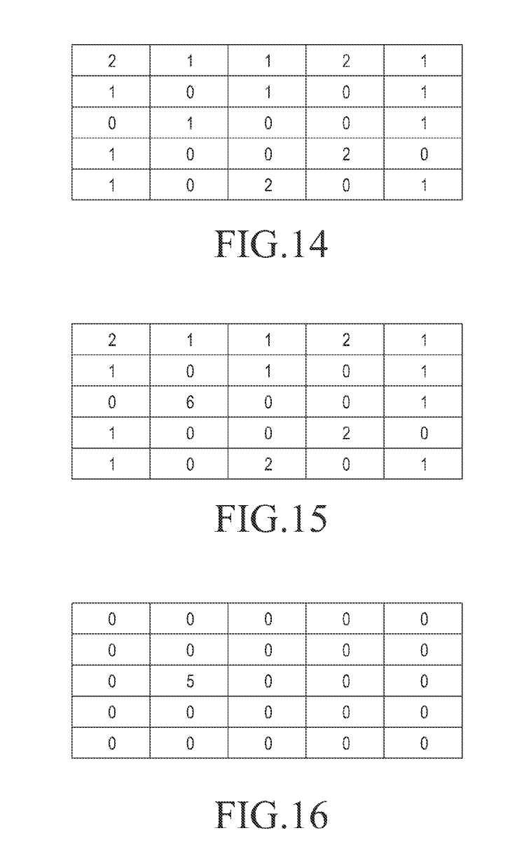

Referring to FIG. 14, when circuit noise exists in the touch screen 900, the sensing values of the entire sensing points 1040 exhibit error values of a certain pattern even if no user input or bending exists.

Referring to FIG. 15, in the state where the error values are not corrected, when the user input means is contacted with the sensing point at third row, second column, the sensing point at third row, second column will output a sensing value in which a capacitance value by the user input (i.e., 5) and the error value (i.e., 1) are added.

Referring to FIG. 16, all the corrected sensing values according to the application of the offset values to the original sensing values of the sensing points 1040 will be 0. When the user input means contacts with the sensing point at third row, second column in the state where the error values are corrected, the sensing point at third row, second column will output a corrected sensing value (i.e., 5) that represents only the capacitance value (i.e., 5).

Referring to FIG. 12 again, the previous offset value compared at S1220 corresponds to the offset value of the previous period.

In step S1230, the control unit 190 compares the row number I with the number of entire rows M (i.e., 5). When I equals M, the control unit 190 ends the method and when I does not equal M, the control unit 190 performs step S1240.

In step S1240, the control unit 190 increases the row number I by 1, and performs step S1220.

In step S1250, the control unit 190 increases the number of offsets by 1 and performs step S1260.

In step S1260, the control unit 190 compares the number of offsets NB with a predetermined second threshold TH2. When NB and TH2 are equal to each other, the control unit 190 performs step S570 and when NB and TH2 are not equal to each other, the control unit 190 performs step S530. More specifically, when NB and TH2 are equal to each other, the control unit 190 determines that the reference column has a bending error (i.e., a bending event occurs).

In step S1270, the control unit 190 updates the offset values by substituting the sensing values of the entire sensing points 1040 for the offset values. More specifically, the control unit 190 performs OS[I, J]=SP[I, J] for I=1 to M and J=1 to N.

An example in which setting is made such that TH1=5, TH2=2 and C=3 in accordance with an embodiment of the present invention is described as follows.

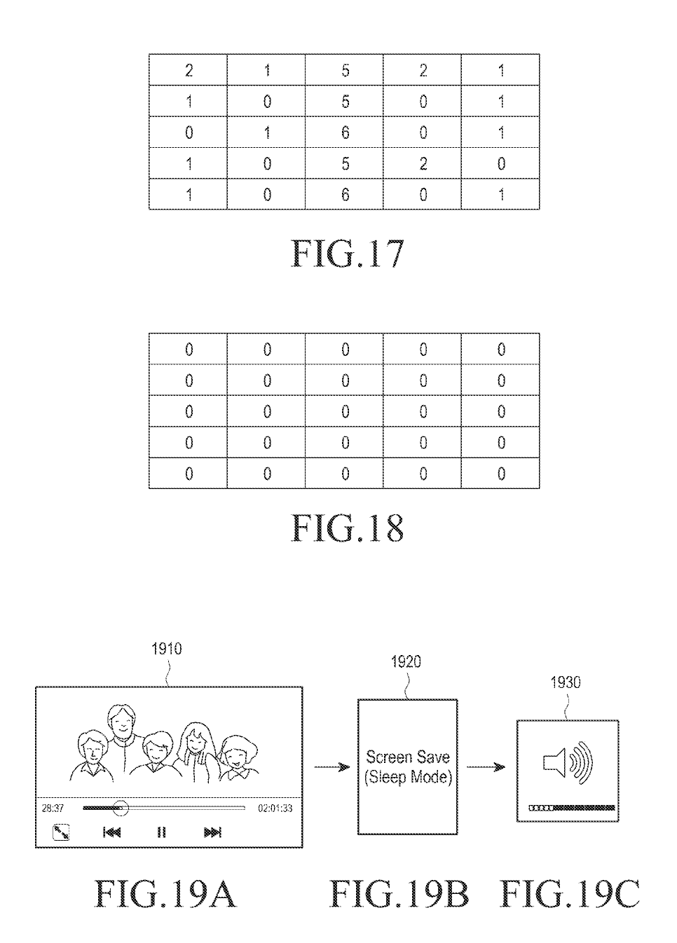

Referring to FIG. 17, the control unit 190 determines that, among the sensing values of the third column, the sensing values of the third row and fourth row (i.e., 65, 70 and 77) satisfy the requirement of step S1220, and from this determination, the control unit 190 determines that a bending event occurs. The control unit 190 updates the offset values by substituting the sensing values of the entire sensing points 1040 for the offset values. More specifically, the control unit 190 performs OS[I, J]=SP[I, J] for I=1 to 5 and J=1 to 5.

Referring to FIG. 18, according to such an offset update, it may be seen that all the corrected values of the entire sensing points 1040 exhibit 0.

Although, in the present example, the reference value that is the target of correction for a sensing value is set to 0, the reference value may be set to an arbitrary value other than 0 in accordance with embodiments of the present invention.

In addition, although, in the present example, the offset values are updated by substituting the sensing values of the entire sensing points for the offset values, such an offset update may be performed only for some of the entire columns or rows, for example, for the columns or rows having a bending error in accordance with embodiments of the present invention.

Meanwhile, although, in the present example, the offset update is performed when bending occurs, ignoring the touch sensing values of the columns having a bending error, merely informing the user of the occurrence of bending, and determining that bending occurs rather than a user input may be considered as an example for preventing erroneous touch recognition, in accordance with embodiments of the present invention.

Since the change in capacitance values vary depending on the bending of the touch screen 900, bending positions may be differentiated and dual bending may be recognized based on each interval or a pitch of the sensing points 1040. Depending on the magnitude of a capacitance value, it is possible to determine the bending direction, i.e., whether the touch screen 900 is bent in the front side direction (i.e., in the direction where the screen is shown) or in the rear side direction and the bending angle may also be calculated. As described above, such capacitance values may be expressed as voltages or digital values according to analog-to-digital conversion.

When bending occurs in the touch screen 900, the control unit 190 may perform an operation or function according to the occurrence of a bending event.

The user may set functions or operations to be performed in accordance with a bending event through an environment setting menu. At this time, the bending direction may also be set in addition to the bending event. For example, the user may set the functions in such a manner that a first function is performed when a bending event in the front side direction of the touch screen 900 occurs and a second function is performed when a bending event in the rear side direction of the touch screen 900 occurs.

FIGS. 19A to 19C are diagrams illustrating execution of a multimedia control function according to a bending event in accordance with a first example of the present invention.

Referring to FIG. 19A, when a user input is not received for a predetermined length of time in a state where a video player 1910 (i.e., video application) is being executed, the process proceeds to a slip mode 1920 in FIG. 19B. When a bending event occurs during the sleep mode 1920, a volume control menu 1930 in FIG. 19C is displayed. At this time, a moving image related menu such as a reproducing menu may be displayed instead of the volume control menu 1930. Alternatively, when a bending event occurs in the front side direction of the touch screen 900 during the sleep mode 1920, the volume is increased and when a bending event in the rear side direction of the touch screen 900, the volume is decreased. In addition, for example, the volume control operation begins when the bending angle arrives at 30 degrees, and as the bending angle increases, the volume may be turned up or turned down.

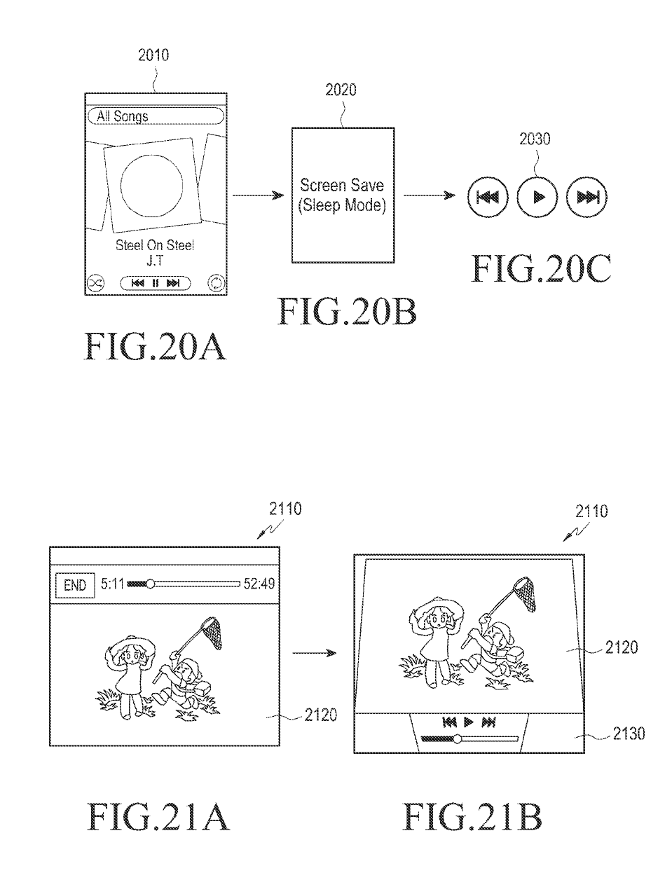

FIGS. 20A to 20C are diagrams illustrating execution of a multimedia control function according to a bending event in accordance with a second example according to an embodiment of the present invention.

Referring to FIG. 20A, when a user input is not received for a predetermined length of time in a state where a music player 2010 (i.e., a music application) is being executed, the process proceeds to a sleep mode 2020, in FIG. 20B. When a bending event occurs during the sleep mode 2020, a volume control menu 2030 in FIG. 20C is displayed. As an alternative, a music related menu, such as a music list menu, and a volume control menu may be displayed instead of the reproducing menu 2030. Alternatively, when a bending event occurs in the front side direction of the touch screen 900 during the sleep mode 2020, one control function from among rewind, fast-forward, pause, and play is performed, and when a bending event occurs in the rear side direction of the touch screen 900 at the slip mode 2020, another control function from among rewind, fast-forward, pause, and play may be performed.

FIGS. 21A and 21B are diagrams illustrating a multimedia control function according to a bending event in accordance with a third example according to an embodiment of the present invention.

Referring to FIG. 21A, the video player 2110 displays only a contents window 2120. When a bending event occurs in a state where a video player 2110 is being executed, a reproducing menu 2130 in FIG. 21B is displayed. At this time, the contents window 2120 is displayed at the upper end of the video player 2110 and the reproducing menu 2130 is displayed at the lower end of the video player 2110. The displaying position of the reproducing menu 2130 may be varied according to the bending direction. For example, when a bending event occurs in the front side direction of the touch screen 900, the reproducing menu may be displayed at the lower end of the video player 2110 and when a bending event occurs in the rear side direction of the touch screen 900, the reproducing menu may be displayed at the upper end of the video player 2110.

The generation of the reproducing menu 2130 may be implemented by a cube screen switching effect that rotates a virtual cube in which the contents window 2120 and the reproducing menu are displayed on adjacent sides, such as depicted in FIG. 21B.

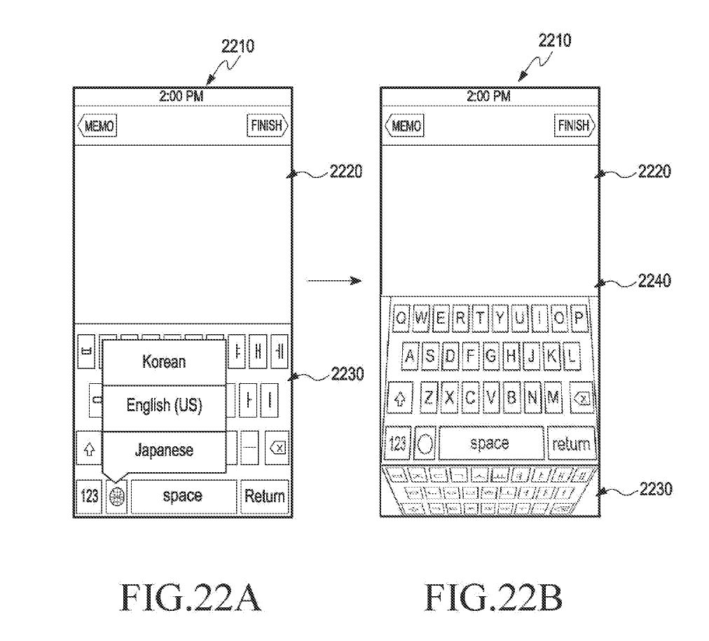

FIGS. 22A and 22B are diagrams illustrating execution of an input interface change function according to a bending event according to an embodiment of the present invention.

In FIG. 22A, a memo window 2220 is displayed at the upper end of the memo application 2210 and an input interface 2230 is displayed at the lower end of the memo application 2210.

When performing conventional language conversion at the time of inputting characters, it is necessary to perform an input by a method such as a method that involves separately touching a conversion button or clicking, and then selecting a language.

By contrast, according to an embodiment of the present invention, when a bending event occurs in a state where the memo application 2210 is being executed, a new English input interface 2240 in FIG. 22B is generated. As shown in FIG. 22A, a Korean input interface 2230 is displayed prior to the occurrence of the bending event and the English input interface 2240 is generated after the occurrence of the bending event. As shown in the present example, the input interface switching may be implemented with a cube screen switching effect that rotates a virtual cube in which a corresponding input interface is displayed on each side. As an alternative, such an input interface switching may be implemented with a sliding screen switching effect in which the input interface gradually disappears while sliding to the left side (or right side) or the upper side (or lower side). Meanwhile, the Korean input interface gradually appears while sliding to the left side (or right side) or the upper side (or lower side). The input interface switching direction may vary according to the bending direction. Accordingly, a new character input environment is provided on a display. The character input environment allows switching between multiple heterogeneous languages, and the languages may include all the existing languages, such as Korean, English, Japanese, Chinese, French and German, for example.

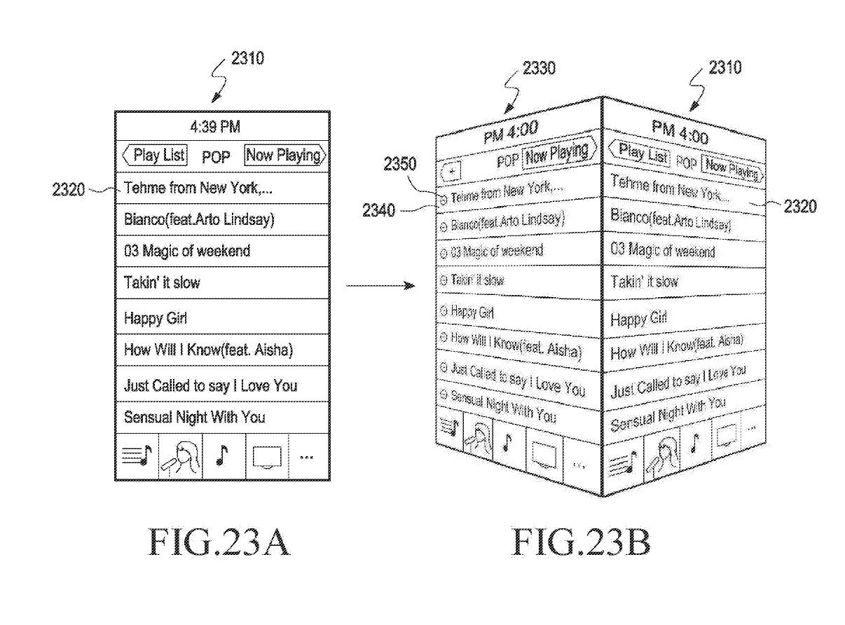

FIGS. 23A and 23B are diagrams illustrating execution of a mode change function according to a bending event according to an embodiment of the present invention.

Referring to FIG. 23A, a music application 2310 operates in a reproducing mode that displays non-editable music items 2320.

When a bending event occurs while the music application 2310 is being executed, the music application 2330 transitions into an editing mode that displays editable music items 2340. The user may click an editing button 2350 or an item itself to perform an editing operation, such as deleting or changing a corresponding item.

Such mode switching may be implemented by a cube screen switching effect that rotates a virtual cube in which a corresponding mode is displayed on each side as exemplified.

As described above with reference to FIGS. 19 to 23, an application interface may be changed in a pre-set method according to the occurrence of a bending event and/or a bending angle.

According to embodiments of the present invention, it is possible to inform a user of a condition of a flexible apparatus by sensing bending or folding occurring in the flexible apparatus. In addition, it is possible to change a graphical user interface to another graphical user interface according to the condition of the flexible apparatus by sensing bending or folding without an additional sensor. Further, it is possible to compensate erroneous touch recognition and at the same time, to enable a touch to be recognized even in a bent or folded state by compensating a capacitance value by bending or folding.

Embodiments of the present invention may be implemented in a form of hardware, software, or a combination of hardware and software. Such arbitrary software may be stored, for example, in a volatile or non-volatile storage device such as a Read-Only Memory (ROM), or, for example, a memory such as a Random Access Memory (RAM), a memory chip, a memory device or an integrated circuit, or a storage medium such as a Compact Disc (CD), a Digital Versatile Disc (DVD), a magnetic disc or a magnetic tape that may be optically or magnetically recorded and readable with a machine (for example, a computer) regardless of whether the software is erasable or rewritable or not. Also, embodiments of the present invention may be implemented by a computer or a portable terminal that includes a control unit and a memory, in which the memory may be a storage medium that is readable by a machine that is suitable for storing one or more programs that include instructions for implementing the embodiments of the present invention. Accordingly, embodiments of the present invention include a program that includes a code for implementing an apparatus or a method defined in any claim in the present specification and a machine-readable storage medium that stores such a program. Further, the program may be electronically transmitted through a medium such as a communication signal transferred through wired or wireless connection, and the present invention properly includes equivalents to the program.

While the present invention has been shown and described with reference to certain embodiments thereof, it will be understood by those skilled in the art that various changes in form and details may be made therein without departing from the spirit and scope of the present invention as defined by the appended claims. Therefore, the scope of the present invention is not defined by the embodiments of the present invention, but by the appended claims and their equivalents.

What is claimed is:

1. A method of processing a bending event of a touch screen in a portable terminal, comprising:
counting a number of touch sensing values of the touch screen;
comparing the number of the touch sensing values with a threshold;
determining that a bending event occurs in the touch screen when the number of the touch sensing values is at least equal to the threshold; and
performing at least one of correction of an error of the touch sensing values and a function of the portable terminal allocated to the bending event upon a determination that the bending event occurs.

2. The method of claim 1, wherein the error of the touch sensing values is corrected by updating offset values to be applied to touch sensing values of a next touch sensing period based on the touch sensing values.

3. The method of claim 1, further comprising detecting touch sensing values of the touch screen that are at least equal to a second threshold,
wherein counting the number of touch sensing values of the touch screen comprises counting a number of the detected touch sensing values.

4. The method of claim 3, wherein, in detecting the touch sensing values, differences between the detected touch sensing values and offset values applied to the touch sensing values of a previous touch sensing period are compared with the second threshold.

5. The method of claim 1, wherein a plurality of sensing points of the touch screen are arranged in a matrix structure, and
the touch sensing values are generated by sensing points arranged in a pre-set column among the plurality of sensing points.

6. The method of claim 4, wherein the touch sensing values indicate capacitance values.

7. The method of claim 1, wherein the function of the portable terminal is one of a multimedia control function, an application interface change function and a mode change function.

8. The method of claim 1, wherein the function of the portable terminal is controlled according to a bending direction or a bending angle.

9. The method of claim 1, wherein the correction of the error of the touch sensing values is performed upon determining that the bending event occurs.

10. The method of claim 1, wherein the function of the portable terminal allocated to the bending event is performed upon determining that the bending event occurs.

11. The method of claim 1, wherein the controller is configured to perform the function of the portable terminal allocated to the bending event upon the determination that the bending event occurs.

12. A flexible portable terminal comprising:
a display unit configured to display an image;
a touch panel configured to output touch sensing values; and
a control unit configured to count the number of touch sensing values of the touch panel, to compare the number of the touch sensing values with a threshold, to determine a bending event occurs in the touch panel when the number of the touch sensing values is at least equal to the threshold, and to perform at least one of correction of an error of the touch sensing values and a function of the portable terminal allocated to the bending event upon a determination that the bending event occurs.

13. The flexible portable terminal of claim 12, wherein the control unit is configured to correct the error of the touch sensing values by updating offset values to be applied to touch sensing values of a next touch sensing period based on the touch sensing values.

14. The flexible portable terminal of claim 12, wherein the function of the portable terminal is one of a multimedia control function, an application interface change function and a mode change function.

15. The flexible portable terminal of claim 12, wherein the function of the portable terminal is controlled according to a bending direction or a bending angle.

16. The flexible portable terminal of claim 12, further comprising:
a printed circuit board assembly including a plurality of rigid regions each of which includes a circuit module, and at least one flexible region disposed between the plurality of rigid regions,
the printed circuit board assembly is bent with reference to the flexible region.

17. The flexible portable terminal of claim 16, wherein the at least one flexible region has a grid form.

18. The flexible portable terminal of claim 12, the controller is configured to detect touch sensing values of the touch screen that are at least equal to a second threshold,
wherein the counted number of touch sensing values is a number of the detected touch sensing values.

19. The flexible portable terminal of claim 12, wherein the controller is configured to perform the correction of the error of the touch sensing values upon the determination that the bending event occurs.

20. A machine-readable storage medium in which a program for executing a method comprising:
counting a number of touch sensing values of the touch screen;
comparing the number of the touch sensing values with a threshold;
determining that a bending event occurs in the touch screen when the number of the touch sensing values is at least equal to the threshold; and
performing at least one of correction of an error of the touch sensing values and a function of the portable terminal allocated to the bending event upon a determination that the bending event occurs.
